(19) United States
(12) Patent Application Publication
(10) Pub. No.: US 2026/0081458 A1
(43) Pub. Date: Mar. 19, 2026

(54) ADJUSTMENT OF TRACTION BATTERY ENERGY RESERVE

(71) Applicant: FORD GLOBAL TECHNOLOGIES, LLC, Dearborn, MI (US)

(72) Inventor: Patrick SODERBORG, Dexter, MI (US)

(21) Appl. No.: 18/887,384

(22) Filed: Sep. 17, 2024

(51) Int. Cl. H02J 9/00; B60L 55/00; B60L 58/12

(52) U.S. Cl. CPC H02J 9/002; B60L 55/00; B60L 58/12; B60L 2240/72; B60L 2260/54

(57) ABSTRACT

After a loss of grid power, a controller prompts a user to set an increased reserve charge level for a traction battery that is based on an amount of energy required to drive the vehicle to a confirmed operable charge station and prevents transfer of power from the traction battery to a building after a charge of the traction battery achieves the increased reserve charge level.

### TECHNICAL FIELD

The present disclosure relates to a system for adjusting a battery energy reserve of an electric vehicle.

### BACKGROUND

An electric vehicle (EV) may be provided with one or more traction batteries for storing electric energy. The electric vehicle may be connected to a home energy ecosystem (HEE) including various components such as a home energy storage (HES), appliance, solar panel, and other devices. During a power outage, the EV may supply electric power to the HEE using the energy stored in the traction batteries.

### SUMMARY

A vehicle includes a traction battery and a controller. The controller, during power transfer from the traction battery to a building and responsive to detecting a reserve charge level for the traction battery being insufficient to drive the vehicle to a nearest charge station, prompts a user regarding an increased reserve charge level and discontinues the power transfer upon a charge of the traction battery achieving the increased reserve charge level.

A method includes, while a traction battery of a vehicle is powering a building, setting an increased reserve charge level for the traction battery, that is based on an amount of energy required to drive the vehicle to currently operable charge stations, responsive to confirmation of a user, discontinuing the powering responsive to a charge of the traction battery achieving the increased reserve charge level, and prompting the user to drive the vehicle to a nearest charge station.

A power system for a vehicle includes a controller that, after a loss of grid power, prompts a user to set an increased reserve charge level for a traction battery that is based on an amount of energy required to drive the vehicle to a confirmed operable charge station that is selected by the controller and prevents transfer of power from the traction battery to a building after a charge of the traction battery achieves the increased reserve charge level.

### BRIEF DESCRIPTION OF THE DRAWINGS

FIG. 1 is a diagram of an electrified vehicle illustrating drivetrain and energy storage components including an electric machine.

FIG. 2 is a diagram of a home energy management system (HEMS) associated with an electric vehicle.

FIG. 3 is a flow diagram of a process for operating the vehicle in a power outage.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes an EV system. More specifically, the present disclosure proposes a system for operating an EV in a power outage.

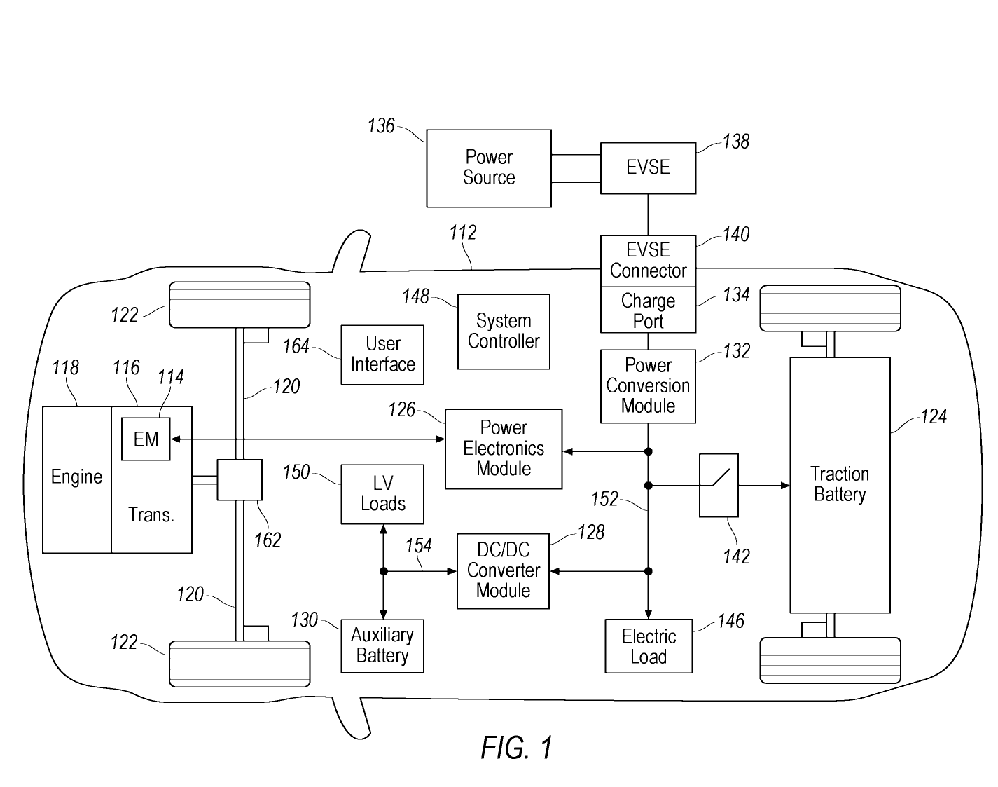

FIG. 1 depicts an electrified vehicle 112 that may be referred to as a plug-in hybrid-electric vehicle (PHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and braking capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. An electrified vehicle 112 may also be a battery electric vehicle (BEV). In a BEV configuration, the engine 118 may not be present.

A traction battery or battery pack 124 stores energy that can be used by the electric machines 114. The vehicle battery pack 124 may provide a high voltage direct current (DC) output. The traction battery 124 may be electrically coupled to one or more power electronics modules 126 (such as a traction inverter). One or more contactors 142 may isolate the traction battery 124 from other components when opened and connect the traction battery 124 to other components when closed. The power electronics module 126 is also electrically coupled to the electric machines 114 and provides the ability to bi-directionally transfer energy between the traction battery 124 and the electric machines 114. For example, the traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

The vehicle 112 may include a variable-voltage converter (VVC) (not shown) electrically coupled between the traction battery 124 and the power electronics module 126. The VVC may be a DC/DC boost converter configured to increase or boost the voltage provided by the traction battery 124. By increasing the voltage, current requirements may be decreased leading to a reduction in wiring size for the power electronics module 126 and the electric machines 114. Further, the electric machines 114 may be operated with better efficiency and lower losses.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads. An output of the DC/DC converter module 128 may be electrically coupled to an auxiliary battery 130 (e.g., 12V battery) for charging the auxiliary battery 130. The low-voltage systems may be electrically coupled to the auxiliary battery 130. One or more electrical loads 146 may be coupled to the high-voltage bus/rail. The electrical loads 146 may have an associated controller that operates and controls the electrical loads 146 when appropriate. Examples of the electrical loads 146 may be a fan, an electric heating element, and/or an air-conditioning compressor.

The electrified vehicle 112 may be configured to recharge the traction battery 124 from an external power source 136. The external power source 136 may be a connection to an electrical outlet. The external power source 136 may be electrically coupled to a charger or electric vehicle supply equipment (EVSE) 138. The external power source 136 may be an electrical power distribution network or grid as provided by an electric utility company. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

Additionally, the vehicle 112 may be configured to provide electric power from the traction battery 124 to off-board power storage (not shown) via the EVSE 138 and EVSE connection 140 under the control of controllers such as the power conversion module 132. Alternatively, the power transfer from the traction battery 124 to the off-board load (e.g., the HES) may be performed without utilizing the power conversion module 132 since both the traction battery 124 and the HES are DC power. The traction battery 124 may be directly connected to the charge port to transfer and/or receive DC power. For instance, the EVSE 138 may be integrated or associated with a home having a HES as power backup. The vehicle 112 may be operated as a portable power storage to transfer power from and to the HES coordinated by a HEMS (to be described in detail below).

Electronic modules in the vehicle 112 may communicate via one or more vehicle networks. The vehicle network may include a plurality of channels for communication. One channel of the vehicle network may be a serial bus such as a controller area network (CAN). One of the channels of the vehicle network may include an Ethernet network defined by the Institute of Electrical and Electronics Engineers (IEEE) 802 family of standards. Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 1 but it may be implied that the vehicle network may connect to any electronic module that is present in the vehicle 112. A vehicle system controller 148 may be present to coordinate the operation of the various components.

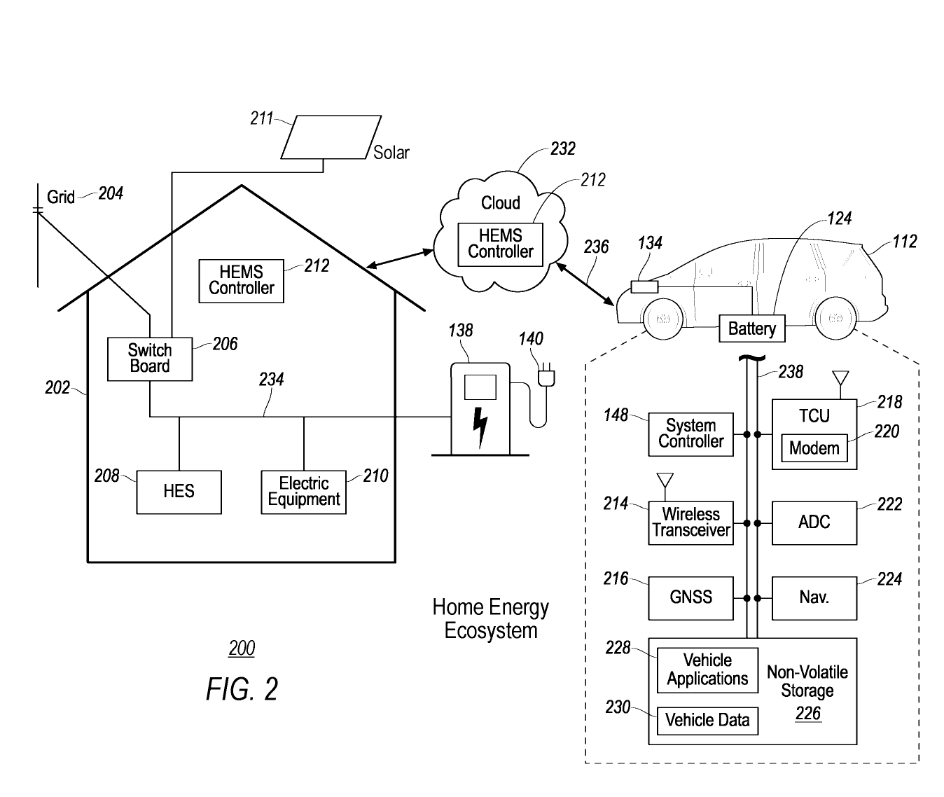

FIG. 2 depicts a diagram of a home energy management system associated with an electric vehicle. The HEE 200 in the present example may be implemented for a house 202. The house 202 may access electric power from a power grid 204 via a switch board 206 configured to provide various components of the HEE 200 with electric power via an internal powerline 234. For instance, the HEE 200 may include one or more electric equipment 210 (e.g., appliance) configured to consume electricity and provide various features to the household. The HEE 200 may further include a HES 208 configured to store electric energy. The HES 208 may be implemented in various forms. As an example, the HES 208 may include a rechargeable battery (e.g., lithium-ion battery) to store electric energy received from the grid 204 and to provide the electric energy to the internal powerline 234 whenever needed. Since the electric energy may be stored as DC power in the HES 208, one or more DC/AC inverters may be provided with the HES 208 for power transitions.

The HEE may be further provided with electric power generating capabilities via one or more power generating devices 211. For instance, the HEE 200 may be provided with one or more renewable energy generators such as a solar panel 211 or a wind turban 211 configured to generate electric power to supply to the HEE 200. The HEE 200 may be provided with one or more non-renewable energy generators such as a gasoline generator 211 or natural gas generators 211.

With continuing reference to FIG. 1, the internal powerline 234 may be further connected to the EVSE 138 configured to transfer electric energy with the electric vehicle 112. The EVSE 138 may be installed within or near the house 202 (e.g., in a garage) and adapted to a home electric energy configuration having a predefined voltage and maximum current supported by the switch board 206. As discussed with reference to FIG. 1, the EVSE 138 may be configured to connect to the vehicle 112 via the charge port 134 to charge the traction battery 124. Additionally, the EVSE 138 may be further configured to draw electric power from the traction battery 124 of the vehicle 112 to supply power to the HEE 200. For instance, in case of a power outage from the grid 204, the EVSE 138 may be configured to draw electric power from the vehicle 112 to power the components of the house 202.

The power management of the HEE 200 may be controlled and coordinated by a HEMS controller 212 associated with the house 202. The HEMS controller 212 may be implemented in various manners. For instance, the HEMS controller 212 may be a dedicated controller located within the house 202 and connected to components of the home energy ecosystem or smart home devices HEE 200 via wired or wireless connections (not shown). Alternatively, the HEMS controller 212 may be implemented by a desktop or laptop computer configured to run processes and programs to perform the controller operations. Alternatively, the HEMS controller 212 may be integrated with one or more components of the home energy ecosystem HEE 200 such as a smart thermostat or the EVSE 138. The HEMS controller 212 may be remotely implemented via a cloud server through the Internet and configured to monitor and control the operations of components of the HEE 200. The HEMS controller 212 may be completely or partially implemented via one or more components of the vehicle 112 (e.g., via the system controller 148). In any or all of the above implementation examples, the HEMS controller 212 may be provided with software to monitor and control the operations of the various components of the HEE 200. The HEMS controller 212 may be further provided with an interface associated with input and output devices to interact with a user of the HEE 200. The HEMS 212 may be further connected to a cloud 232 via a public or private network to communicate with other entities such as the utility company and charging stations to facilitate the energy transfer between the vehicle 112 and the house 202.

With continuing reference to FIG. 1, the vehicle 112 may further include various components to facilitate the power transaction between the battery 124 and the EVSE 138. The vehicle 112 may include a system controller 148 configured to perform instructions, commands, and other routines in support of the processes described herein. For instance, the system controller 148 may include one or more processors and be configured to execute instructions of vehicle application 228 to provide features such as wireless communication and power management. Such instructions and other data may be maintained in a non-volatile manner using a variety of computer-readable storage medium 226. The computer-readable medium 226 (also referred to as a processor-readable medium or storage) may include any non-transitory medium (e.g., tangible medium) that participates in providing instructions or other data that may be used by the system controller 148. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and SQL.

The vehicle 112 may further be provided with navigation and route planning features through a navigation controller 224 configured to calculate navigation routes responsive to user input via, for example, HMI controls (not shown) and output planned routes and instructions via an output device such as a speaker or a display (not shown). Location data that is needed for navigation may be collected from a global navigation satellite system (GNSS) controller 216 configured to communicate with multiple satellites and calculate the location of the vehicle 112. The GNSS controller 216 may be configured to support various current and/or future global or regional location systems such as global positioning system (GPS), Galileo, Beidou, Global Navigation Satellite System (GLONASS), and the like. Map data used for route planning may be stored in the storage 226 as a part of the vehicle data 230. Navigation software may be stored in the storage 226 as a part of the vehicle applications 228.

The vehicle 112 may be further configured to wirelessly communicate with a variety of digital entities via a wireless transceiver 214. For instance, the vehicle 112 may be configured to communicate with the HEMS controller 212 via the wireless transceiver 214 to perform various operations. The communication between the vehicle 112 and the HEMS controller may be enabled by the EVSE connector 140 coupled with the charge port 134 configured to support digital communication protocols. The wireless transceiver 214 may be configured to support a variety of wireless communication protocols enabled by wireless controllers (not shown) in communication with the wireless transceiver 214. As a few non-limiting examples, the wireless controllers may include a Wi-Fi controller, a Bluetooth controller, a radio-frequency identification (RFID) controller, a near-field communication (NFC) controller, and other devices such as a Zigbee transceiver, an IrDA transceiver, an ultra-wide band (UWB) transceiver, or the like.

The vehicle 112 may be further provided with a telematics control unit (TCU) 218 configured to control telecommunication between the vehicle 112 and the cloud 232 through a wireless connection 236 using a modem 220. The wireless connection 236 may be in the form of various communication network (e.g., a cellular network). Through the wireless connection 236, the vehicle 112 may access one or more servers of the cloud 232 to access various content for various purposes. The vehicle 112 may access the one or more server of the cloud 232 via the wireless transceiver 214 though the house 202 (e.g., via Wi-Fi and home Internet). For instance, the vehicle 112 may access one or more servers associated with a utility company to communicate information about one or more current or future power outages in the area in which the HEE 200 is located such that the vehicle 112 and/or the HEMS 212 may coordinate the energy distribution between various entities of the HEE 200. Additionally, the vehicle 112 may access one or more servers associated with one or more charging stations to communicate information about the availability and reservations of the charging stations. Additionally, the vehicle 112 may access local traffic and road conditions in real time via one or more servers such that the navigation controller 224 may determine the optimal route to one or more destinations such as a charging station.

The vehicle 112 may be further provided with autonomous driving features via an autonomous driving controller (ADC) 222. The ADC 222 may be configured to perform autonomous driving for the vehicle 112 in conjunction with the navigation controller 224 using map data stored in the storage 226 and live data from the cloud 232. For instance, the ADC 222 may operate the vehicle 112 to a destination such as a charging station to charge the traction battery 124 in an autonomous manner without requiring a human driver onboard. Upon completion of the charging, the ADC 222 may operate the vehicle 112 back to the house 202 in an autonomous manner.

The term cloud is used as a general term in the present disclosure and may include any computing network involving carriers, router, computers, servers, or the like configured to store data and perform data processing functions and facilitate communication between various entities.

The various components of the vehicle 112 introduced above may be connected to each other via in-vehicle network 238. The in-vehicle network 238 may include, but is not limited to, one or more of a CAN, an Ethernet network, and a media-oriented system transport (MOST), as some examples.

According to the present disclosure, the vehicle 112 may configured to interact with various components of the HEE 200 to perform various operations. For instance, in situations of a power outage for the house 202, the vehicle 112 may supply electric energy to the house 202 using the traction battery 124. In this case, a battery energy reserve level may be set for the traction battery 124 such that the vehicle 112 will have sufficient electric energy to arrive at one or more charging stations. For instance, if arriving at the nearest charging station from the house 202 requires 5% SOC of the traction battery 124, the system controller 148 of the vehicle 112 may set the energy reserve level to be at least 5%. In practice, a buffer (e.g., an additional 3% SOC) is usually added to the energy reserve level. Responsive to the traction battery 124 arriving at the energy reserve level, the vehicle 112 may stop outputting the electric energy to the HEE 200 and request the user to drive the vehicle 112 to the charging station for charging the battery 124. The vehicle 112 may monitor the availability of a plurality of nearby charging stations and dynamically adjust the energy reserve level.

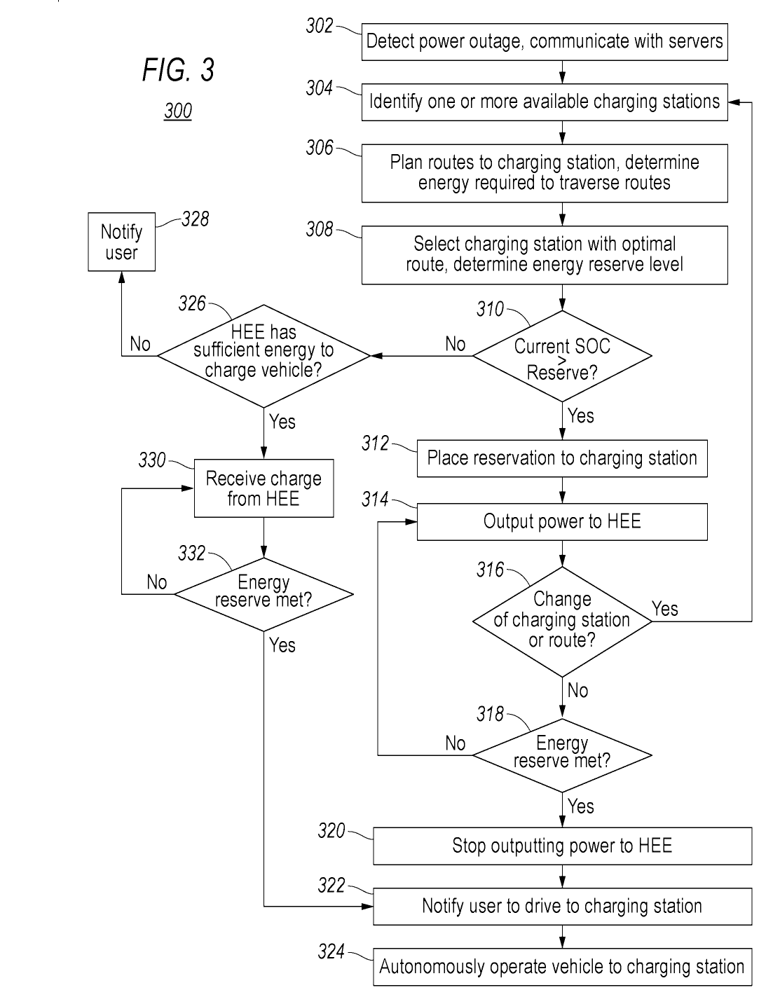

Referring to FIG. 3, an example flow diagram of process 300 for operating the vehicle 112 in a power outage of one embodiment of the present disclosure is illustrated. With continuing reference to FIGS. 1 and 2, the process 300 may be implemented via one or more components of the vehicle 112 (e.g., via the system controller 148). The process 300 may be completely or partially implemented via one or more components of the HEE 200 (e.g., via the HEMS controller 212). For simplicity, the following description will primarily be made with reference to the system controller 148 of the vehicle 112 although the present disclosure is not limited thereto. It is noted that although the process 300 may be applied to various types of vehicles such as hybrid electric vehicles and PHEVs, the process 300 is more applicable to BEVs due to the larger battery capacity. The following description will be made with reference to the BEV 112.

At operation 302, responsive to detecting a power outage of the house 202 while the vehicle 112 is connected to the HEE 200 via the EVSE 138, the system controller 148 connects to one or more remote servers at the cloud 232 to retrieve various information. As discussed above, the vehicle 112 may access the servers to retrieve various information such as availability of nearby charging stations, traffic/road conditions or the like. The system controller 148 may be configured to preferably access the cloud 232 via a local/home connection (e.g., home internet) for cost savings. In situations the home Internet is unavailable (e.g., due to the power outage), the system controller 148 may access the cloud 232 via the wireless connection 236 using the modem 220 independent from the local connection.

At operation 304, the system controller 148 identifies one or more available nearby charging stations using the information retrieved from the servers. In general, a power outage may affect one or more areas and the operations of the one or more charging stations may also be affected. The system controller 148 may predefine a list of candidate charging stations based on their distance from the house 202. Responsive to detecting one or more of those candidates are not operating (e.g., also affected by the outage), the system controller 148 exclude those candidates from the list such that those candidate charging station that are still available are identified. It is noted that operation 304 as well as other operations of the process 300 may be continuously performed such that system controller 148 may dynamically update the identification in real time. For instance, a first charging station may be out of power and therefore excluded by the system controller 148 at a first instance. The power of the first charging station may be subsequently restored and the system controller 148 may include the first charging station at a subsequent second instance (e.g., 1 hour later).

At operation 306, the system controller 148 and/or the navigation controller 224 of the vehicle 112 plans one or more routes to the available charging stations as previously identified and determines amounts of energy required to arrive at the charging stations traversing the routes. Depending on the length and road condition (e.g., pavement, speed limit) of the routes, the required energy amount may vary significantly. In addition, if the power outage is associated with a natural disaster such as a hurricane, some roads in the affected area may be blocked. The navigation controller 24 may also take that information into account when planning the routes. Similar to operation 304, the route information may be dynamically updated using the traffic and road condition information retrieved from the servers in real time. Responsive to receiving updated traffic and road condition information, the navigation controller 224 may update the routes to one or more destination charging stations and the system controller 148 may adjust the required energy amount accordingly.

At operation 308, the system controller 148 selects one of the routes as an optimal route with the destination to the selected charging station and determines an energy reserve level for the traction battery 124. In general, a shorter and more energy efficient route is preferred. The system controller 148 may select the most energy efficient route as the optimal route. The energy reserve level may be determined using the required energy amount for the vehicle 112 to traverse the optimal route. The system controller 148 may set the energy reserve level using the required energy plus a buffer energy amount. For instance, if the optimal route requires 8% SOC and the buffer is set to 5%, the system controller 148 may set the energy reserve level to be 13%. The buffer may be manually set by the user of the vehicle 112. Alternatively, the system controller may automatically adjust the buffer based on various factors such as the required amount of energy to traverse the optimal route. As an example, a longer optimal route requiring more energy may result in a higher buffer energy amount, whereas a shorter optimal route requiring less energy may results in a lower buffer energy amount.

With the energy reserve level determined, at operation 310, the system controller 148 determines whether the current energy level/SOC of the traction battery 124 is above the energy reserve level.

If the answer for operation 310 is yes, the process proceeds to operation 312 and places a reservation of the selected charging station associated with the optimal route. The time of the reservation may be determined via one or more factors such as a predicted discharge time and a travel time from the house 202 to the selected charging station. For instance, if the system controller 148 predicts that it will take approximately 2 hours to discharge the traction battery 124 to the energy reserve level and it will take approximate 15 minutes to drive to the selected charging station via the optimal route, the system controller 148 may place a reservation with the selected charging station for 2:15 hours later.

At operation 314, the system controller 148 operates the vehicle 112 to supply electric power to the HEE 200 using the traction battery 124. The system controller 148 may corporate with the HEMS controller 212 to determine the output power and operate the traction battery 124 accordingly. For instance, only essential devices (e.g., fridge, modem, lights) of the HEE 200 may be powered in the power outage. Non-essential devices (e.g., gaming console) may not be supplied with electric power during the outage. In addition, the system controller 148 and/or the HEMS controller 212 may also take the power generating device 211 into account for determining the output power of the traction battery 124. For instance, responsive to a current or predicted sunny weather, the power and energy generated by the solar panel may be determined and used to adjust the power output of the traction battery 124.

As discussed above, the system controller 148 may dynamically update and adjust the optimal route with the selected charging station based on live data retrieved from the servers. At operation 316, the system controller 148 monitors the live data from the server and determines if there is a change of the one or more charging stations and/or the routes to the charging stations. There are a number of factors that may cause the change. For example, the selected charging station may become unavailable due to updated power outage information. The optimal route to the selected charging station may become unavailable due to traffic controls. Alternatively, better options of candidate charging stations and routes may become available due to emergency services and repairs.

If the answer for operation 316 is yes, indicative of a change of the one or more charging stations and/or the routes, the process 300 returns to operation 304 and the system controller 148 repeats the operations 304 to 314.

If the answer for operation 316 is no, indicative of currently no change of the one or more charging stations and/or the routes, the process 300 proceeds to operation 318 and the system controller 148 verifies if the energy reserve level as previously determined has been reached. The system controller 148 may monitor the SOC of the traction battery 124 and provide updates to the user regularly. The system controller 148 may provide notification to the user once the SOC of the traction battery 124 is close to the energy reserve level (e.g., within 3%).

If the energy reserve level has not been met, the process 300 returns to operation 314 and the system controller 148 continues to discharge the traction battery 124 to supply power to the HEE 200.

Otherwise, if the answer for operation 318 is yes, indicative of the traction battery 124 having reached the energy reserve level, the process 300 proceeds to operation 320 and the system controller 148 stops outputting the electric power to the HEE 200 such that the SOC of the traction battery 124 does not drop below the energy reserve level.

At operation 322, the system controller 148 notifies the user about the battery level and requests the user to drive to the reserved charging station to recharge the traction battery 124. The system controller 148 may communicate with the user in various manners. For instance, the system controller 148 may output audio and/or visual messages via the user interface 164 of the vehicle 112. The system controller 148 may send the message to a mobile device associated with the user (e.g., a mobile phone) via the wireless transceiver 214. The system controller 148 may send the message to a mobile device associated with the user via the cloud 232 through the TCU 218. Responsive to receiving the message from the vehicle 112, the user may disconnect the vehicle 112 from the EVSE 138 and drive to the reserved charging station. Navigation instructions of the optimal routes may be provided to the user while driving the vehicle 112.

At operation 324, the vehicle 112 may drive to the charging station in an autonomous manner via the ADC 222 with or without a human driver inside.

Returning to operation 310, if the system controller 148 determines the current SOC of the traction battery 124 is below the energy reserve level, indicative of the SOC of the traction battery 124 being insufficient for the vehicle 112 to arrive at the selected charging station, the process proceeds to operation 326.

At operation 326, the system controller 148 in cooperation with the HEMS controller 212 determines if the HEE 200 is able to provide the vehicle 112 with electric energy that is sufficient for the vehicle 112 to arrive at the selected charging station via the optimal route. As discussed above, the HEE 200 may be provided with energy storage devices (e.g., the HES 208) and/or energy generating devices 211. For instance, the system controller 148 may determine the current SOC of the HES 208 is sufficient to charge the traction battery 124 of the vehicle 112 to arrive at the energy reserve level. The system controller 148 may determine that the energy generating device 211 may generate sufficient electric power to charge the traction battery 124 to the energy reserve level.

If the answer for operation 326 is no, the process 300 proceeds to operation 328 and the system controller 148 notifies the user about the insufficient energy situation. Recommendations such as contacting mobile charging services may also be provided to the user.

If the answer for operation 326 is yes, indicative of the HEE 200 being able to provide the traction battery 124 with sufficient electric energy to the energy reserve level, the process 300 proceeds to operation 330.

At operation 330, the system controller 148 in cooperation with the HEMS controller 212 charges the traction battery 124 using the energy from the HEE (e.g., via the HES 208 and/or the power generating device 211).

At operation 332, the system controller 148 verifies if the SOC of the traction battery 124 has arrived at the energy reserve level. If the answer is no, the process 300 returns to operation 330 and the vehicle 112 continues to receive electric energy from the HEE 200.

If the answer for operation 332 is yes, indicative of the energy reserve level having been reached, the process 300 proceeds to operation 322 to notify the vehicle user as described above.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery; and
a controller programmed to, during power transfer from the traction battery to a building and responsive to detecting a reserve charge level for the traction battery being insufficient to drive the vehicle to a nearest charge station, prompt a user regarding an increased reserve charge level and discontinue the power transfer upon a charge of the traction battery achieving the increased reserve charge level.

2. The vehicle of claim 1, wherein the controller is further programmed to identify operable charge stations in a vicinity of the vehicle.

3. The vehicle of claim 2, wherein the controller is further programmed to select among the operable charge stations based on an amount of energy required to drive the vehicle to each of the operable charge stations.

4. The vehicle of claim 3, wherein the increased reserve charge level is based on the amount of energy required to drive the vehicle to at least one of the operable charge stations.

5. The vehicle of claim 2, wherein the controller is further programmed to reserve at least one of the operable charge stations for use by the vehicle.

6. The vehicle of claim 1, wherein the controller is further programmed to prompt a user to drive the vehicle to a charge station after the power transfer has been discontinued.

7. The vehicle of claim 1, wherein the controller is further programmed to prompt a user to drive the vehicle to a charge station before the power transfer has been discontinued.

8. The vehicle of claim 1, wherein the reserve charge level is user defined.

9. A method comprising:
while a traction battery of a vehicle is powering a building, setting an increased reserve charge level for the traction battery, that is based on an amount of energy required to drive the vehicle to currently operable charge stations, responsive to confirmation of a user, discontinuing the powering responsive to a charge of the traction battery achieving the increased reserve charge level, and prompting the user to drive the vehicle to a charge station.

10. The method of claim 9 further comprising prompting the user to confirm the increased reserve charge level responsive to detecting a reserve charge level for the traction battery being insufficient to drive the vehicle to a nearest charge station.

11. The method of claim 9, wherein the prompting is before the discontinuing.

12. The method of claim 9, wherein the prompting is after the discontinuing.

13. The method of claim 9 further comprising reserving one of the currently operable charge stations for use by the vehicle.

14. A power system for a vehicle comprising:
a controller programmed to, after a loss of grid power, prompt a user to set an increased reserve charge level for a traction battery that is based on an amount of energy required to drive the vehicle to a confirmed operable charge station that is selected by the controller and prevent transfer of power from the traction battery to a building after a charge of the traction battery achieves the increased reserve charge level.

15. The power system of claim 14, wherein the controller is further programmed to select among confirmed operable charge stations based on an amount of energy required to drive the vehicle to each of the confirmed operable charge stations.

16. The power system of claim 14, wherein the controller is further programmed to reserve the confirmed operable charge station for use by the vehicle.

17. The power system of claim 14, wherein the controller is further programmed to prompt a user to drive the vehicle to the confirmed operable charge station before the charge achieves the increased reserve charge level.

18. The power system of claim 14, wherein the controller is further programmed to prompt a user to drive the vehicle to the confirmed operable charge station after the charge achieves the increased reserve charge level.
